(19) United States
(12) Patent Application Publication
(10) Pub. No.: US 2023/0105568 A1
(43) Pub. Date: Apr. 6, 2023

(54) TRANSLATING ARTIFICIAL NEURAL NETWORK SOFTWARE WEIGHTS TO HARDWARE-SPECIFIC ANALOG CONDUCTANCES

(71) Applicant: INTERNATIONAL BUSINESS MACHINES CORPORATION, Armonk, NY (US)

(72) Inventors: Charles Mackin, San Jose, CA (US); Geoffrey Burr, San Jose, CA (US); Jonathan Paul Timcheck, Palo Alto, CA (US)

(21) Appl. No.: 17/491,910

(22) Filed: Oct. 1, 2021

(51) Int. Cl. G06N 3/063; G06N 3/04

(52) U.S. Cl. CPC G06N 3/0635; G06N 3/04

(57) ABSTRACT

Translation of artificial neural network (ANN) software weights to analog conductances in the presence of conductance non-idealities for deployment to an analog non-volatile memory device is provided. A plurality of target synaptic weights of an artificial neural network is read. The plurality of target synaptic weights is mapped to a plurality of conductance values, each of the plurality of target synaptic weights being mapped to at least one of the plurality of conductance values. A hardware model is applied to the plurality of conductance values, thereby determining a plurality of hardware-adjusted conductance values, the hardware model corresponding to an analog non-volatile memory device. The plurality of hardware-adjusted conductance values is mapped to a plurality of hardware-adjusted synaptic weights. The plurality of conductance values is optimized in order to minimize an error metric between the target synaptic weights and the hardware-adjusted synaptic weights.

### BACKGROUND

Embodiments of the present disclosure relate to analog neural networks, and more specifically, to for translating artificial neural network (ANN) software weights to analog conductances in the presence of conductance non-idealities.

### BRIEF SUMMARY

According to embodiments of the present disclosure, methods and computer program products for adapting an artificial neural network for deployment to an analog non-volatile memory device are provided. A plurality of target synaptic weights of an artificial neural network is read. The plurality of target synaptic weights is mapped to a plurality of conductance values, each of the plurality of target synaptic weights being mapped to at least one of the plurality of conductance values. A hardware model is applied to the plurality of conductance values, thereby determining a plurality of hardware-adjusted conductance values, the hardware model corresponding to an analog non-volatile memory device. The plurality of hardware-adjusted conductance values is mapped to a plurality of hardware-adjusted synaptic weights. The plurality of conductance values is optimized in order to minimize an error metric between the target synaptic weights and the hardware-adjusted synaptic weights.

According to embodiments of the present disclosure, systems are provided that include an analog non-volatile memory device and a computing node. The computing node includes a computer readable storage medium having program instructions embodied therewith, the program instructions executable by a processor of the computing node to cause the processor to perform a method. A plurality of target synaptic weights of an artificial neural network is read. The plurality of target synaptic weights is mapped to a plurality of conductance values, each of the plurality of target synaptic weights being mapped to at least one of the plurality of conductance values. A hardware model is applied to the plurality of conductance values, thereby determining a plurality of hardware-adjusted conductance values, the hardware model corresponding to an analog non-volatile memory device. The plurality of hardware-adjusted conductance values is mapped to a plurality of hardware-adjusted synaptic weights. The plurality of conductance values is optimized in order to minimize an error metric between the target synaptic weights and the hardware-adjusted synaptic weights.

In various embodiments, the optimized plurality of conductance values is applied to the analog non-volatile memory device. In various embodiments, the optimized plurality of conductance values are stored.

In various embodiments, the error metric is a time-averaged, normalized error metric. In various embodiments, the error metric is a time-averaged normalized mean squared error. In various embodiments, the error metric is a time-averaged normalized mean absolute error. In various embodiments, the error metric is a down-sampled time-weighted normalized mean squared error. In various embodiments, the error metric is a down-sampled time-weighted normalized mean absolute error.

In various embodiments, optimizing the plurality of conductance values comprises determining a coefficient and a constant adjustment to each of the plurality of conductance values.

In various embodiments, each of the plurality of target synaptic weights is mapped to at least two conductance values having opposite signs. In various embodiments, each of the plurality of target synaptic weights is mapped to at least two conductance values having different magnitudes. In various embodiments, each of the plurality of target synaptic weights is mapped to four conductance values, G⁺, G⁻, g⁺, and g⁻, wherein G⁺>g⁺ and G⁻>g⁻, and G⁺, g⁺ are added while G⁻, g⁻ are subtracted to obtain a resulting current.

In various embodiments, the hardware model comprises one or more of weight programming error, read noise, conductance drift, and drift variability. In various embodiments, optimizing the plurality of conductance values comprises evolving the plurality of conductance values as a function of time based on the hardware model.

In various embodiments, the analog non-volatile memory device comprises an array of resistive elements, the array providing a vector of current outputs equal to the analog vector-matrix product between (i) a vector of voltage inputs to the array encoding a vector of analog input values and (ii) the plurality of conductance values within the array.

### BRIEF DESCRIPTION OF THE SEVERAL VIEWS OF THE DRAWINGS

FIG. 1 illustrates an exemplary nonvolatile memory-based crossbar array, or crossbar memory.

FIG. 2 illustrates exemplary synapses within a neural network.

FIG. 3 illustrates an exemplary array of neural cores according to embodiments of the present disclosure.

FIG. 4 illustrates a method to optimize weight programming according to embodiments of the present disclosure.

FIGS. 5A-B is an alternate view of a method to optimize weight programming according to embodiments of the present disclosure.

FIGS. 6A-F illustrate the results of weight programming optimization according to embodiments of the present disclosure.

FIGS. 7A-F illustrate results of generalizing drift models according to embodiments of the present disclosure.

FIGS. 8A-F illustrate further results of generalizing drift models according to embodiments of the present disclosure.

FIGS. 9A-D illustrate further results of generalizing drift models according to embodiments of the present disclosure.

FIGS. 10A-D illustrate further results of generalizing drift models according to embodiments of the present disclosure.

FIGS. 11-12 illustrate an exemplary distribution and exemplary histogram (respectively) according to embodiments of the present disclosure.

FIGS. 13A-F illustrate the weight programming space according to embodiments of the present disclosure.

FIG. 14 illustrates a method of adapting an artificial neural network for deployment to an analog non-volatile memory device.

FIG. 15 depicts a computing node according to an embodiment of the present disclosure.

### DETAILED DESCRIPTION

Artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from the preceding layer and the strength of the connections as determined by the synaptic weights. An ANN is trained to solve a specific problem (e.g., pattern recognition) by adjusting the weights of the synapses such that a particular class of inputs produce a desired output.

ANNs may be implemented on various kinds of hardware, including crossbar arrays, also known as crosspoint arrays or crosswire arrays. A basic crossbar array configuration includes a set of conductive row wires and a set of conductive column wires formed to intersect the set of conductive row wires. The intersections between the two sets of wires are separated by crosspoint devices. Crosspoint devices function as the ANN's weighted connections between neurons.

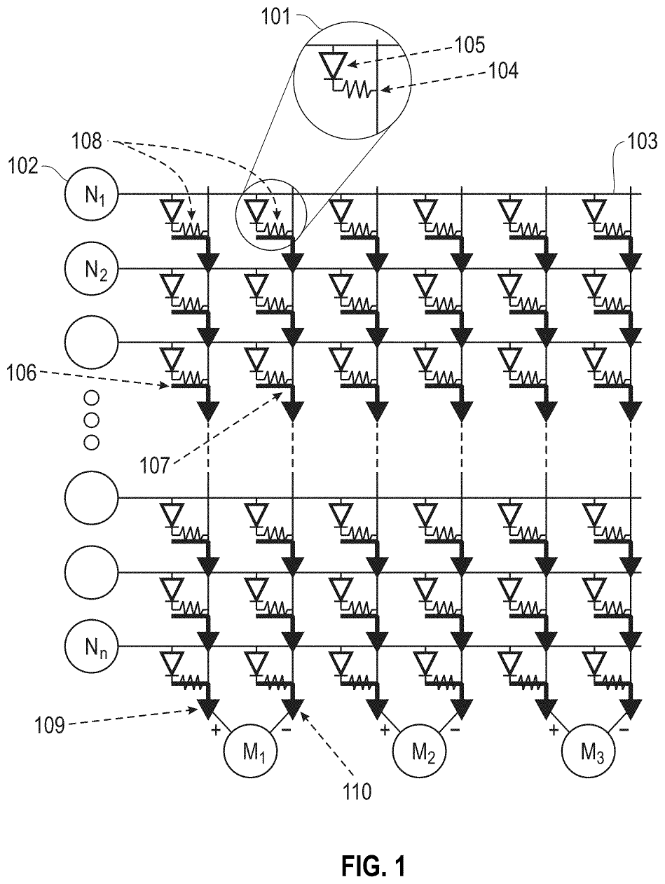

Referring to FIG. 1, an exemplary nonvolatile memory-based crossbar array, or crossbar memory, is illustrated. A plurality of junctions 101 are formed by row lines 102 intersecting column lines 103. A resistive memory element 104, such as a non-volatile memory, is in series with a selector 105 at each of the junctions 101 coupling between one of the row lines 102 and one of the column lines 103. The selector may be a volatile switch or a transistor, various types of which are known in the art.

It will be appreciated that a variety of resistive memory elements are suitable for use as described herein, including memristors, phase-change memories, conductive-bridging RAMs, spin-transfer torque RAMs.

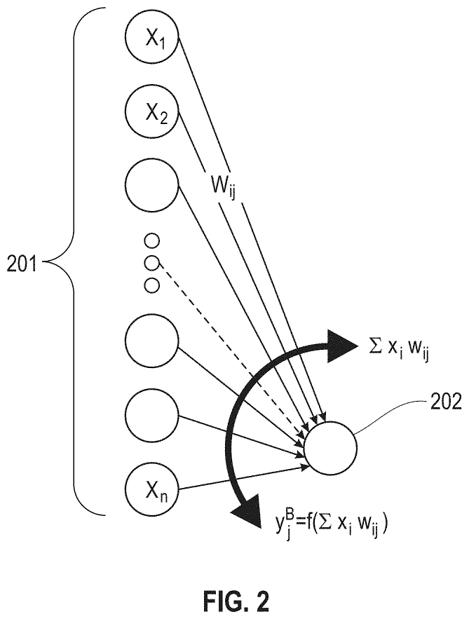

Referring to FIG. 2, exemplary synapses within a neural network are illustrated. A plurality of inputs x₁ . . . xₙ from nodes 201 are multiplied by corresponding weights wᵢⱼ. The sum of the weights, Σxᵢwᵢⱼ is provided to a function ƒ(·) at node 202 to arrive at a value yⱼ^{B}=ƒ(Σxᵢwᵢⱼ). It will be appreciated that a neural network would include a plurality of such connections between layers, and that this is merely exemplary.

Mapping the exemplary synapses of FIG. 2 onto the crossbar array of FIG. 1, the current at the output 106, 107 of each junction is given as I=G⁺V(t) and I=G⁻V(t) where G⁺ and G⁻ correspond to wᵢⱼ for the given resistive memory, and V(t) correspond to xᵢ for the given input row line. In this example, the column lines are arranged in adjacent conductance pairs 108. The currents are aggregated with opposite polarity to achieve subtraction. The aggregate outputs 109, 110 are thus given as I=ΣG⁺V and I=ΣG⁻V for each conductance pair 108.

In such crossbar memories, the aggregate output current can be extremely high. In addition, large voltage drops and electromigration may lead to a loss of functionality of the array. Moreover, to sense a single input device or crosspoint (rather than the aggregate read current from many devices), downstream peripheral circuitry would need to have a very high dynamic range.

A fixed number of synapses may be provided on a core, and then multiple cores connected to provide a complete neural network. In such embodiments, interconnectivity between cores is provided to convey outputs of the neurons on one core to another core, for example, via a packet-switched or circuit-switched network. In a packet-switched network, greater flexibility of interconnection may be achieved, at a power and speed cost due to the need to transmit, read, and act on address bits. In a circuit-switched network, no address bits are required, and so flexibility and re-configurability must be achieved through other means.

In various exemplary networks, a plurality of cores is arranged in an array on a chip. In such embodiments, relative positions of cores may be referred to by the cardinal directions (north, south, east, west).

In various embodiments of the present disclosure, each neuron on the edge of each core is connectable to a dedicated routing fabric for that particular neuron. The routing fabric comprises a mesh of wires, buffers, and switches that are associated with that particular neuron within the overall data vector corresponding to all neurons at the core edge. While the routing fabric for a single neuron is described in various examples herein, it will be understood that all neurons (or elements of the data-vector) travel in parallel on their own dedicated routing lines. In various embodiments, one or more control lines control all or a substantial fraction of the parallel lines simultaneously. In other embodiments, a register of mask bits allows masked control of a subset of the parallel lines.

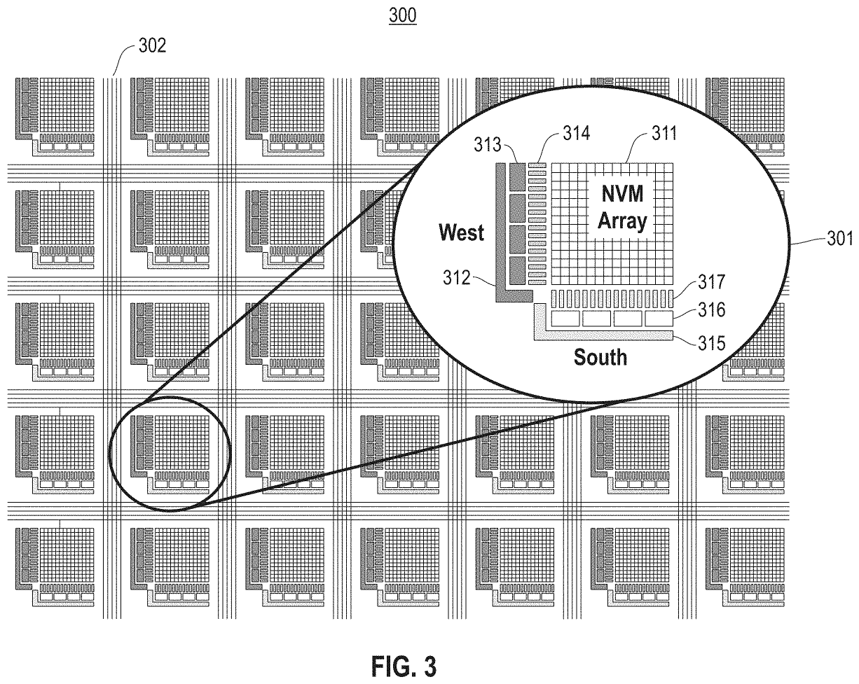

Referring now to FIG. 3, an exemplary array of neural cores is illustrated according to embodiments of the present disclosure. Array 300 includes a plurality of cores 301. The cores in array 300 are interconnected by lines 302, as described further below. In this example, the array is two-dimensional. However, it will be appreciated that the present disclosure may be applied to a one-dimensional or three-dimensional array of cores. Core 301 includes non-volatile memory array 311, which implements synapses as described above. Core 301 includes a west side and a south side, each of which may serve as input while the other serves as output. The west side includes support circuitry 312, which is dedicated to the entire side of core 301, shared circuitry 313, which is dedicated to a subset of rows, and per-row circuitry 314, which is dedicated to individual rows. The south side likewise includes support circuitry 315, which is dedicated to the entire side of core 301, shared circuitry 316, which is dedicated to a subset of columns, and per-column circuitry 317, which is dedicated to individual columns. It will be appreciated that the west/south nomenclature is adopted merely for ease of reference to relative positioning, and is not meant to limit the direction of inputs and outputs.

It will be appreciated that during operation as a classifier, the array of cores may be trained using a variety of methods known in the art. Certain algorithms may be suitable for specific tasks such as image recognition, speech recognition, or language processing. Training algorithms lead to a pattern of synaptic weights that, during the learning process, converges toward an optimal solution of the given problem. Backpropagation is one suitable algorithm for supervised learning, in which a known correct output is available during the learning process. The goal of such learning is to obtain a system that generalizes to data that were not available during training.

In general, during backpropagation, the output of the network is compared to the known correct output. An error value is calculated for each of the neurons in the output layer. The error values are propagated backwards, starting from the output layer, to determine an error value associated with each neuron. The error values correspond to each neuron's contribution to the network output. The error values are then used to update the weights. By incremental correction in this way, the network output is adjusted to conform to the training data. During backpropagation, the vectors of data may be travelling between cores in the opposite direction to that used during forward propagation. Accordingly, if data-vectors were passed from the south side of, e.g., core 3 to the west-side of, e.g., core 4 during forward-propagation, during backpropagation, data-vectors may need to be passed in reverse: from the west side of core 4 to the south side of core 3.

When applying backpropagation, an ANN rapidly attains high accuracy on most of the examples in a training-set. The vast majority of training time is spent trying to further increase this test accuracy. During this time, a large number of the training data examples lead to little correction, since the system has already learned to recognize those examples. While in general, ANN performance tends to improve with the size of the data set, this can be explained by the fact that larger data-sets contain more borderline examples between the different classes on which the ANN is being trained.

Accordingly, during training, array 300 may be provided with example data and example labels. Inferred classifications may be provided as output. Based on the inferred classifications, weight overrides may be provided to the array of cores. In turn, updated weights may be read from the array.

Artificial Neural Network (ANN) software-trained weights are unitless. In order to configure neural network hardware to execute a train neural network, these unitless weights must be translated into conductances for analog memory-based accelerators. In addition, analog ANN weights are typically implemented by one or more non-volatile memory (NVM) devices. There is not a straightforward and universally applicable method to translate unitless software weights into analog hardware weights implemented by multiple NVM elements. This is exacerbated by the presence of variable MSP/LSP scale factors F and NVM non-idealities such as programming errors due to stochasticity in the conductance-vs-pulse characteristic, read noise, conductance-dependent drift, and/or drift variability.

This problem is not specific to Phase-Change Memory (PCM)-based approaches, and is applicable to any analog memory for ANN hardware acceleration.

The present disclosure provides methods to optimize the translation of Artificial Neural Network (ANN) software-trained weights (generally unitless) into analog weights implemented using non-volatile memory (generally given in microSiemens).

The methods provided herein are capable of finding complex and non-trivial weight programming strategies that are able to minimize the weight errors over time so as to achieve and maintain the best possible inference accuracy. In various embodiments, this is achieved numerically by using a time-averaged normalized mean-squared error metric, which takes into account non-volatile memory (NVM) non-idealities such as programming errors, read noise, and conductance-dependent drift characteristics, and potentially hardware-specific algorithmic drift compensation techniques.

One advantage of this approach is that the weight programming optimization is performed numerically and can consider many NVM non-idealities simultaneously, including many different complex stochastic and nonlinear behaviors. This optimization can also be performed without running any costly inference simulations. The error metric serves as a proxy for inference accuracy. Accordingly, the present disclosure provides automated methods to solve for optimal weight programming strategies in a quantitative manner that is highly flexible and can readily re-optimize weight programming for any combination of non-ideal NVM behavior.

In various embodiments, methods are provided to optimize the ANN weight programming strategy to allow for NVM targets to be complex functions of

W_{T}:G⁺(W_{T}),G⁻(W_{T}),g⁺(W_{T}),g⁻(W_{T}).

These methods operate on the principle that preserving the ideal (hardware-aware trained) weights as accurately as possible also preserves the inference accuracy of the artificial neural network. This is supported empirically, as set forth below, and also mathematically. As the weight errors approach zero, the deep neural network (DNN) inference accuracy returns to the hardware-aware software-trained DNN accuracy as well.

This is achieved using a time-averaged normalize mean squared error (MSE) metric, although other error metrics such as time-average normalized mean absolute error (MAE) may be used as well. The error metric is minimized in the presence of NVM-specific device characteristics such as programming stochastically and errors, read noise, and conductance-dependent drift, and drift compensation etc. (also can be readily extended to include additional weight/conductance non-idealities).

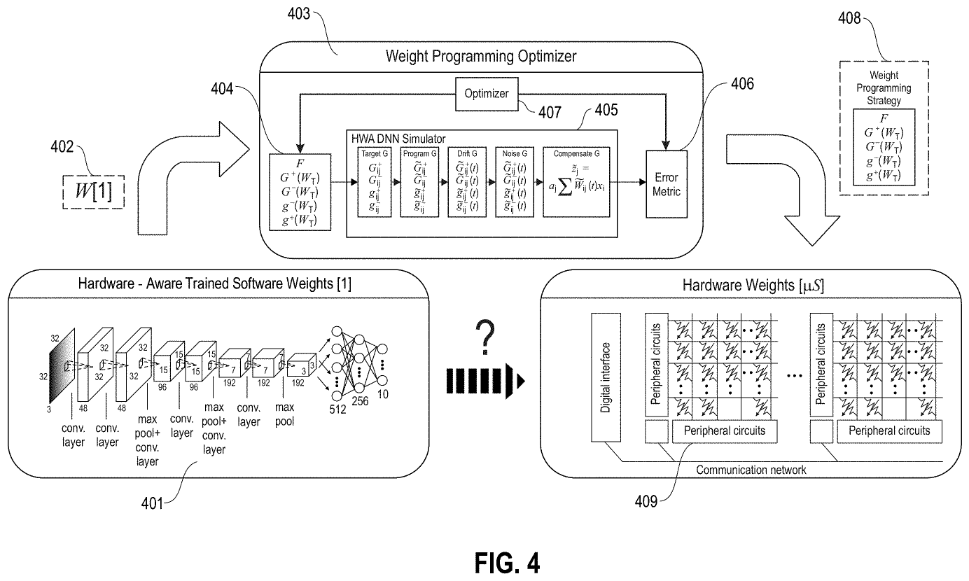

Referring to FIG. 4, a method to optimize weight programming is illustrated according to the present disclosure. Weights for a software defined neural network 401 are trained using methods known in the art, yielding weights 402. Weights 402 are provided to optimizer 403 for translation into a weight programming strategy suitable for target hardware. Within optimizer 403, input hardware configuration parameters 404 are provided to simulator 405. In various embodiments, parameters 404 include a plurality of conductances that are encoded in the physical substrate to configure the neural network. In some embodiments, a single conductance G is provided. In some embodiments, positive and negative conductances G⁺ and G⁻ are provided. In some embodiments, large positive and negative conductances G⁺ and G⁻ are provided along with smaller positive and negative conductances g⁺ and g⁻ for fine tuning.

In some embodiments, a multiplier F is additionally provided as a multiplier on G and or g values. In exemplary embodiments, W=F(G⁺−G⁻)+g⁺g⁻.

It will be appreciated that in various physical implementations, conductances vary over time, while software weights do not. Accordingly, the selection of conductance values appropriate to the physical substrate is critical to a resilient encoding of neural network weights in hardware.

Simulator 405 applies a hardware model to the input conductances 404 in order to determine error metric 406, indicative of the hardware driven variance between the target weights and the effective weights. The error metric 406 is provided to optimizer 407, which revises parameters 404. The process of simulation and optimization repeats until error metric 406 is below a predetermined threshold. The conductances are then provided to physical substrate 409 in order to implement neural network 401.

Hardware-specific non-idealities are incorporated during the forward propagation during hardware-aware training. Software weight updates during backward propagation are based on stochastic gradient descent (SGD) and carried out at full precision without additional noise. While this makes DNN models more resilient to weight errors including those resulting from conductance drift, hardware-aware training does not explicitly incorporate any conductance drift models. Later, during inference evaluation of the test dataset over time, all hardware non-idealities—MAC cycle-to-cycle non-idealities, PCM programming noise, read noise, 1/f noise, conductance-dependent drift, drift variability, and drift compensation—are considered.

Although the above example uses stochastic gradient descent (SGD), it will be appreciated that a variety of optimization methods may be used with the objective functions set out herein. Exemplary methods include, but are not limited to, non-coordinate descent methods, conjugate gradient methods, gradient descent, subgradient methods, bundle methods of descent, ellipsoid methods, conditional gradient methods, quasi-Newton methods, simultaneous perturbation stochastic approximation (SPSA) method for stochastic optimization, memetic algorithms, differential evolution, evolutionary algorithms, dynamic relaxation, genetic algorithms, hill climbing with random restart, Nelder-Mead simplicial heuristic, particle swarm optimization, gravitational search algorithm, simulated annealing, stochastic tunneling, Tabu search, reactive search optimization (RSO), forest optimization algorithm.

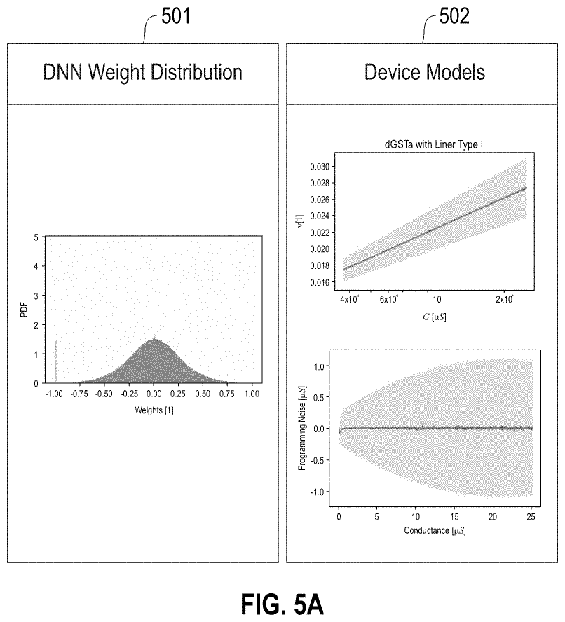

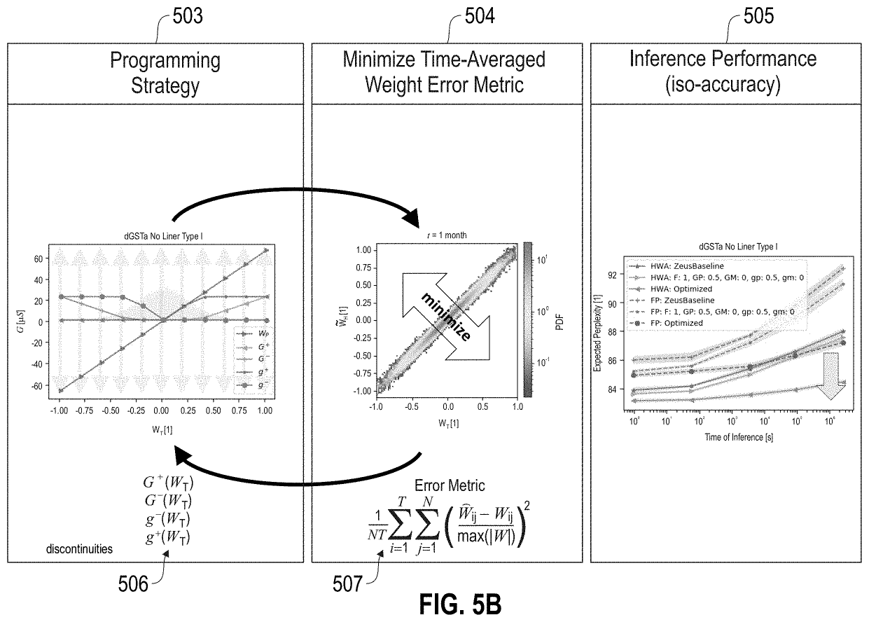

Referring to FIGS. 5A-B, an alternate view is provided of a method to optimize weight programming according to the present disclosure. A given neural network has a certain distribution of weights 501. One or more device model 502 as described herein may be applied to the weight distribution in order to determine a time averaged weight error metric 504 based on the programming strategy 503. At 505, the inference performance of the optimized weight programming is measured. As set out herein, minimizing weight errors over time (i.e., preserving weight fidelity) improves inference performance.

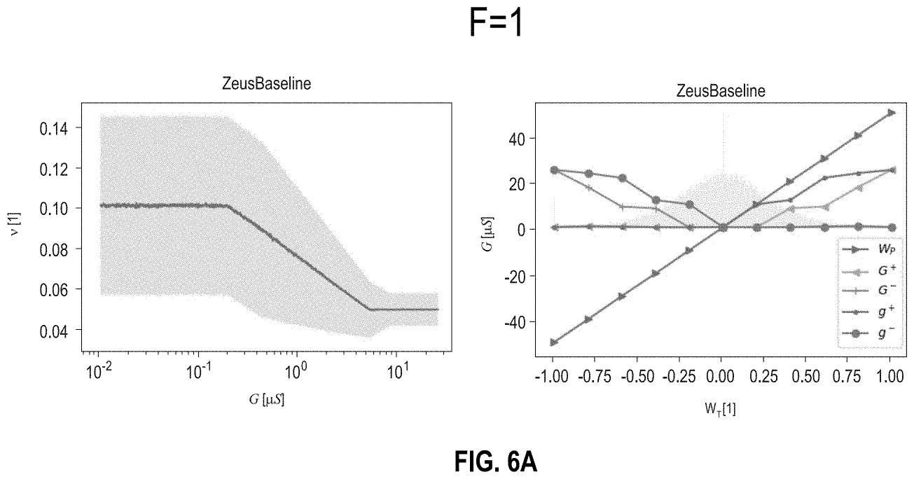

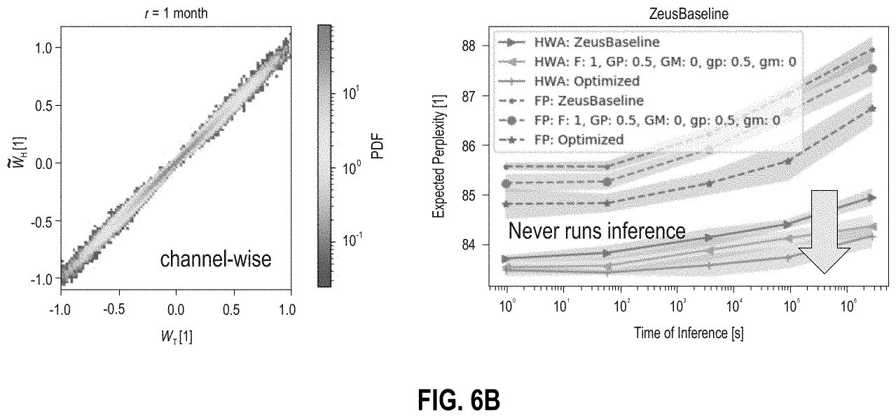

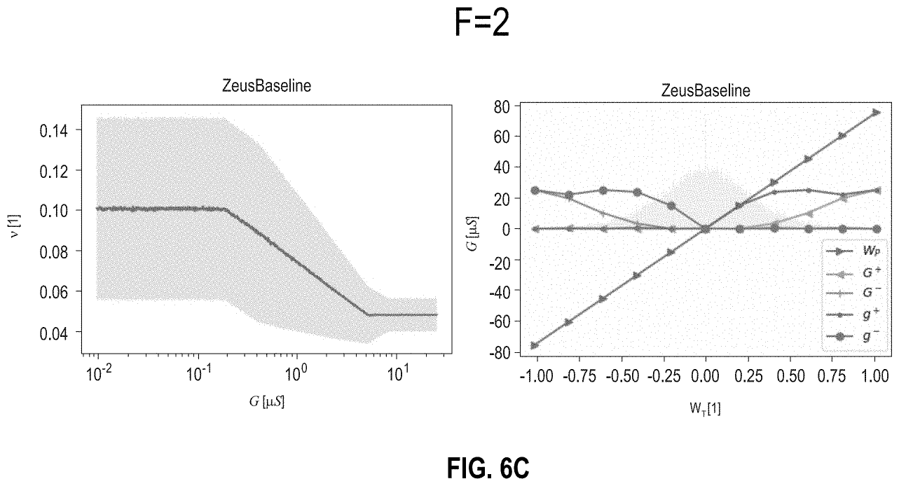

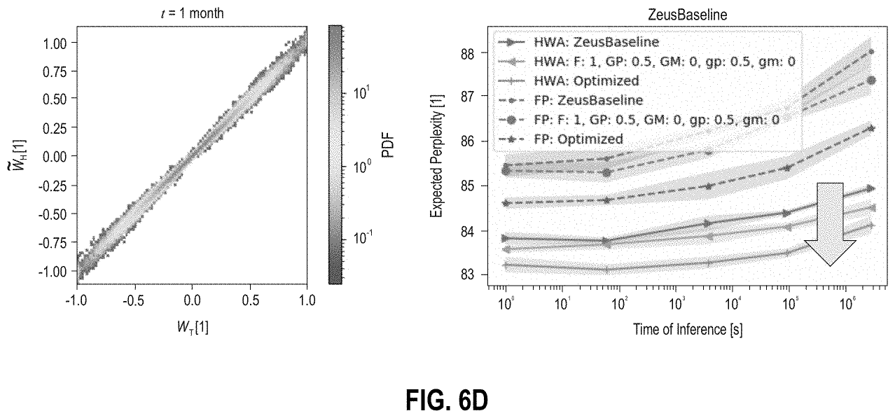

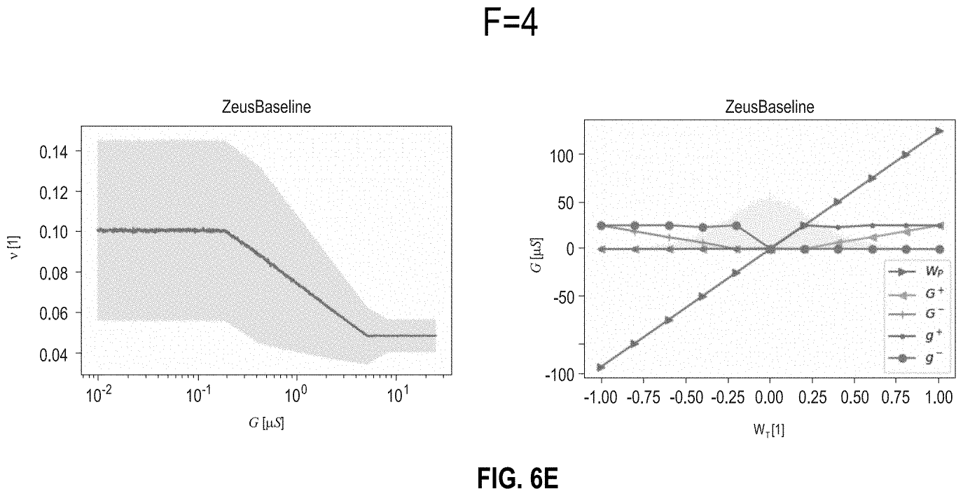

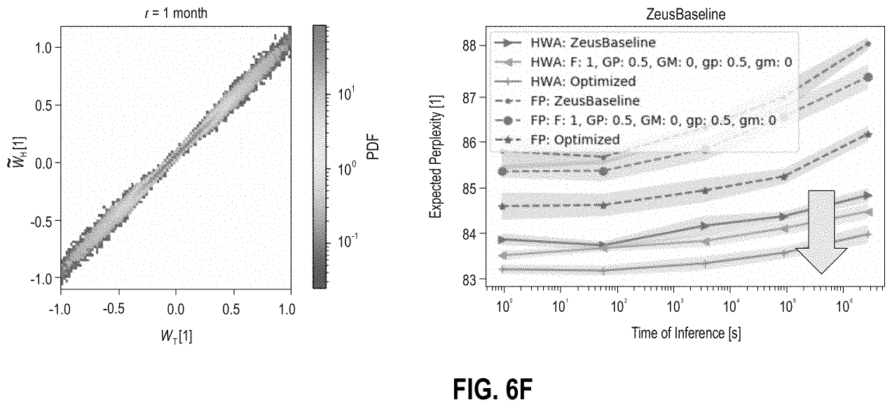

Referring to FIGS. 6A-F, the results of weight programming optimization according to the present disclosure are illustrated. FIGS. 6A-B correspond to F=1. FIGS. 6C-D correspond to F=2. FIGS. 6E-F correspond to F=4. In this scenario, read_noise=prog_noise=1.0 normalized to the intrinsic read and programming noise of the device. The programming strategy changes with the F factor. F=2 was the best in term of time-averaged NMSE score in this example, (F1=0.00068, F2=0.00064, F4=0.00066). In this example, symmetry is enforced, and noise is independent for G⁺, G⁻, g⁺, and g⁻ (and gets amplified).

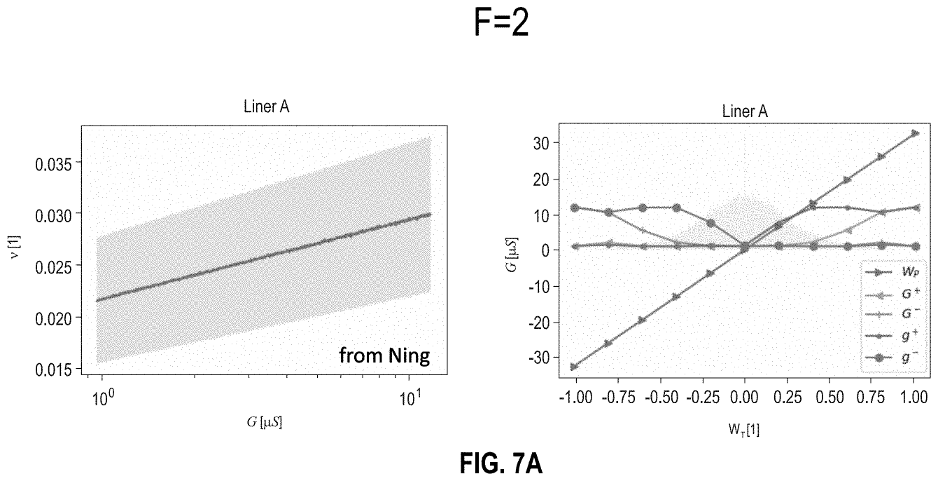

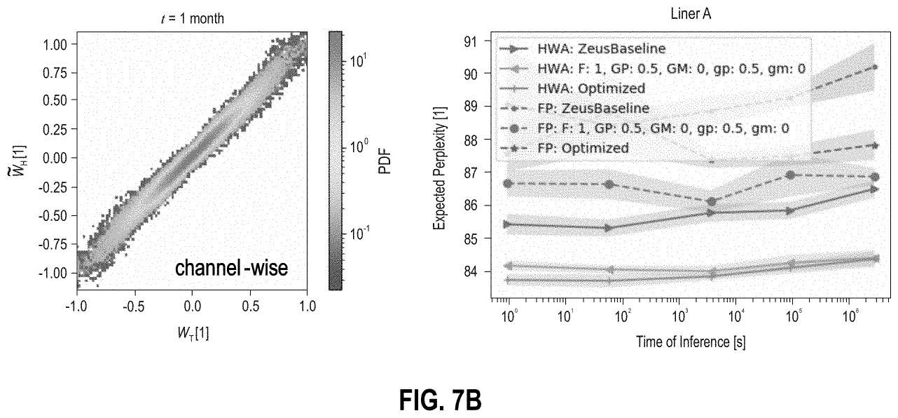

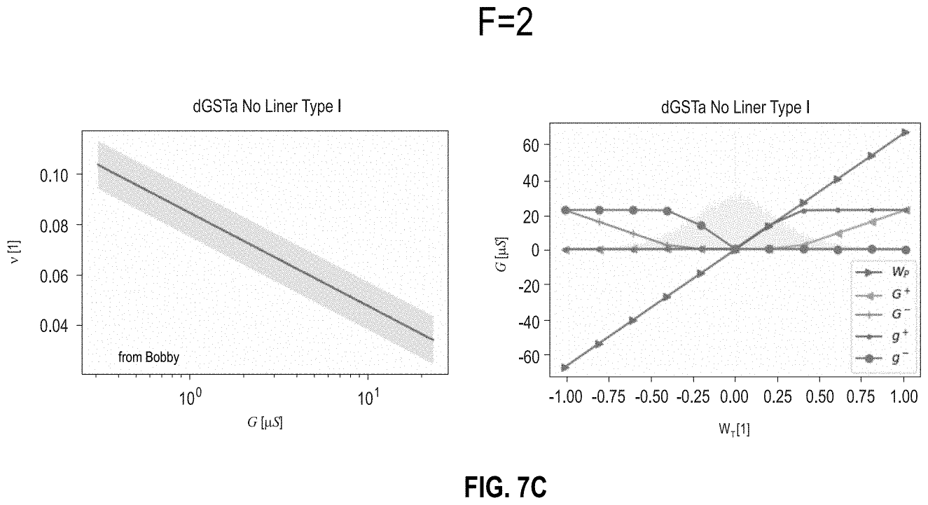

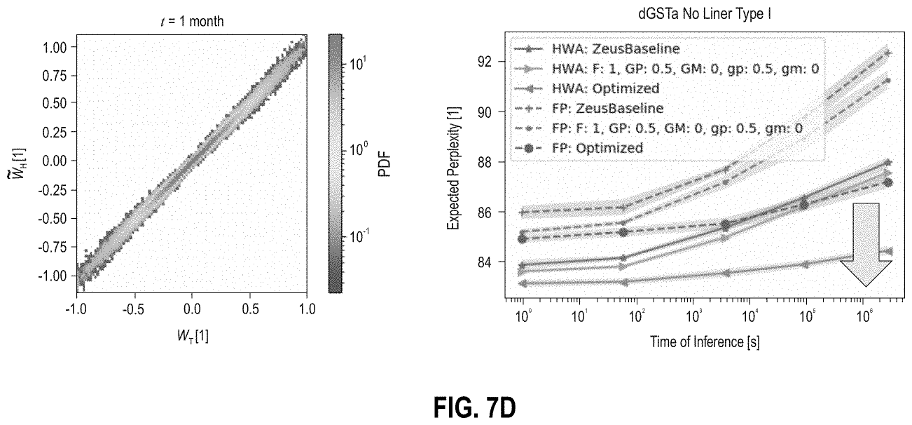

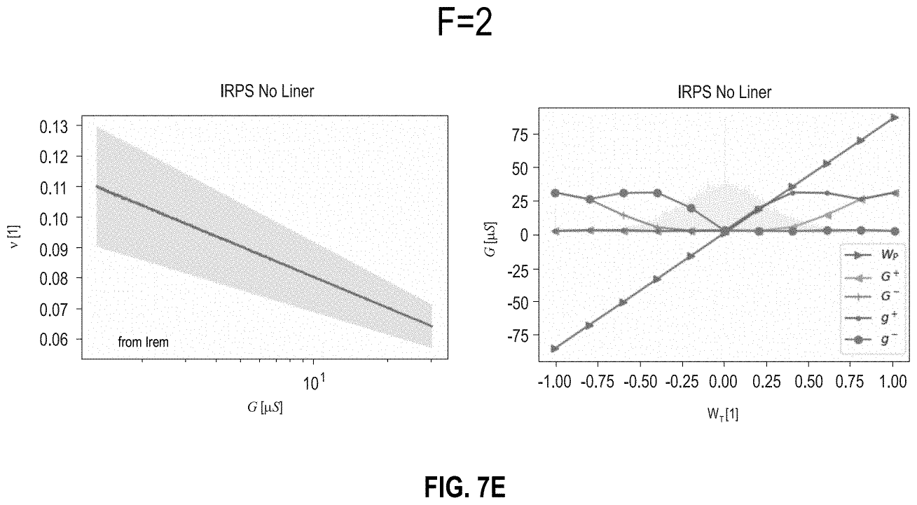

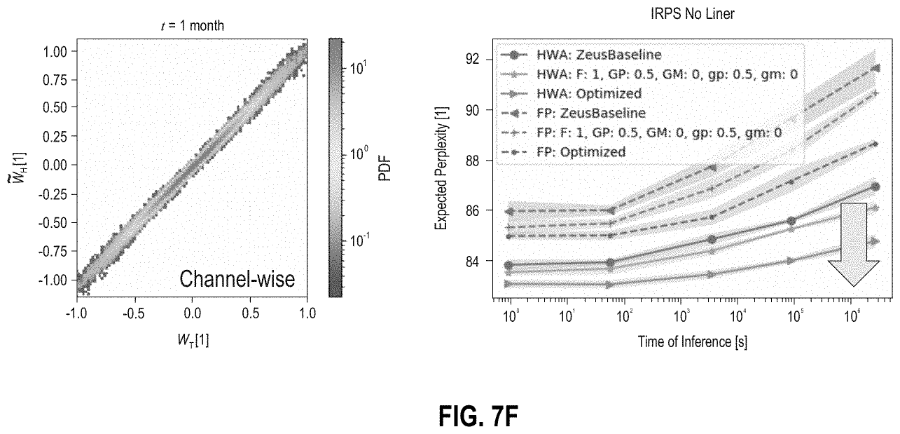

Referring to FIGS. 7A-F, results of generalizing the model to different drift models are shown. FIGS. 7A-B correspond to a first case, FIGS. 7C-D correspond to a second case, and FIGS. 7E-F correspond to a third case. In this example, while different drift models are used, the same programming noise and read noise model is used. This shows both positive and negative sloping conductance-dependent drift and changing standard deviation. In this example, symmetry is enforced, and noise is independent for G⁺, G⁻, g⁺, and g⁻ (and gets amplified).

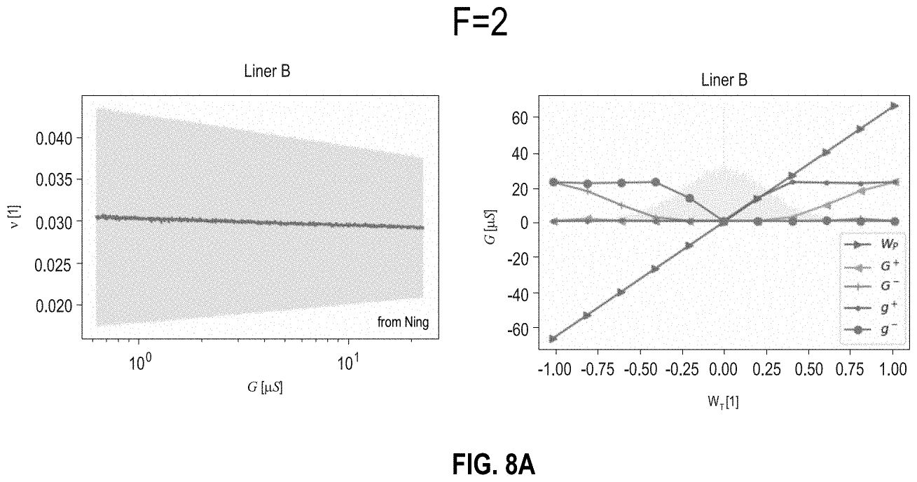

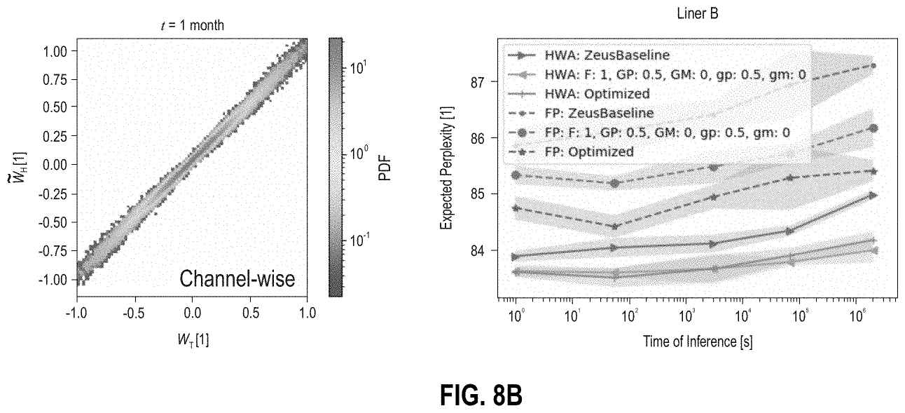

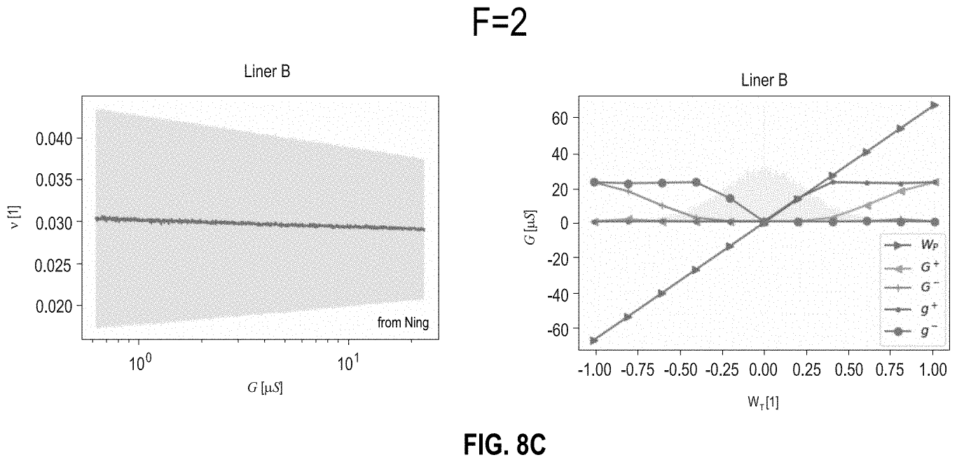

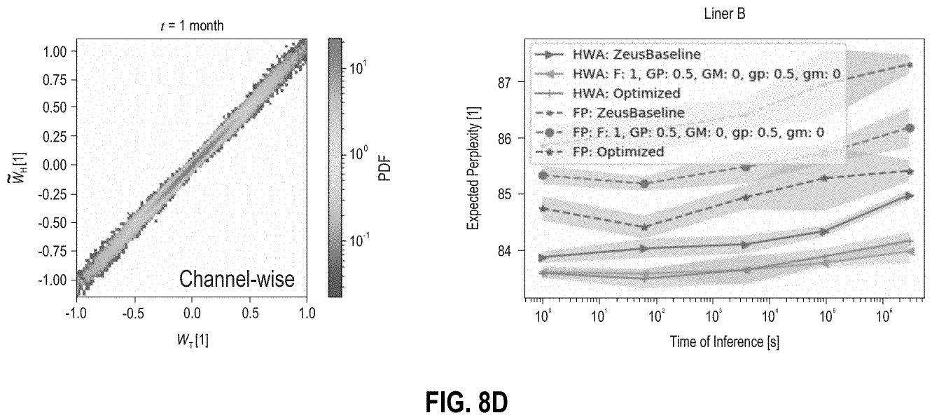

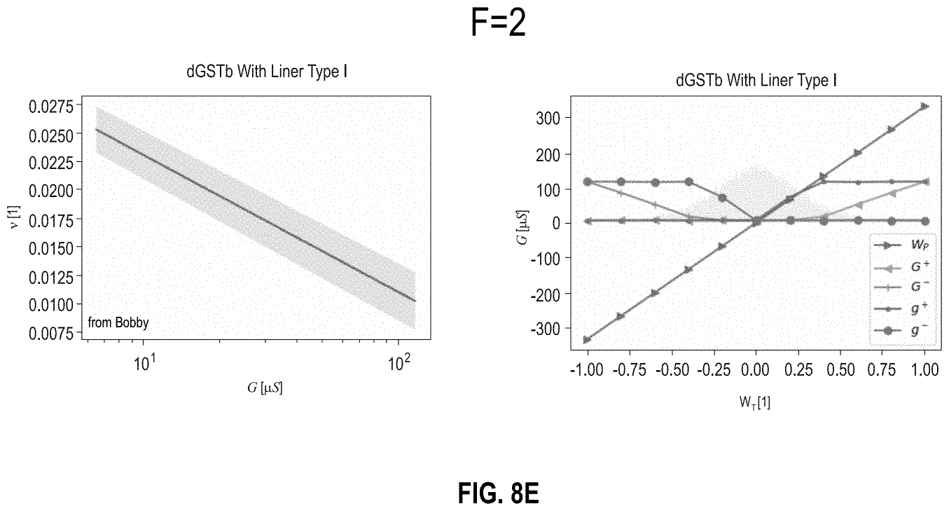

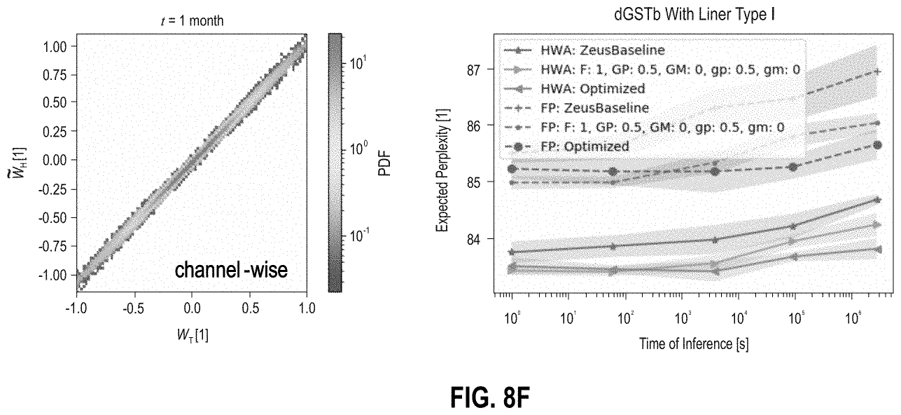

Referring to FIGS. 8A-C, further results of generalizing the model to different drift models are shown. FIGS. 8A-B correspond to a first case, FIGS. 8C-D correspond to a second case, and FIGS. 8E-F correspond to a third case.

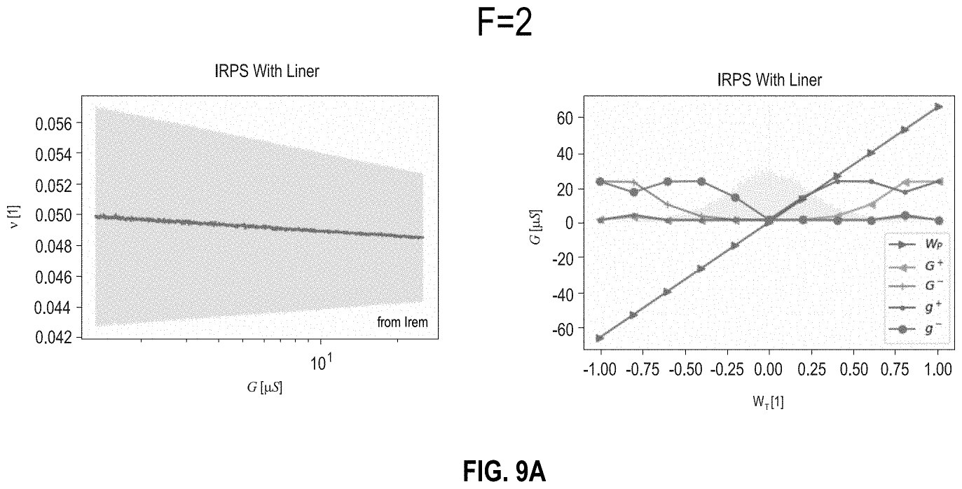

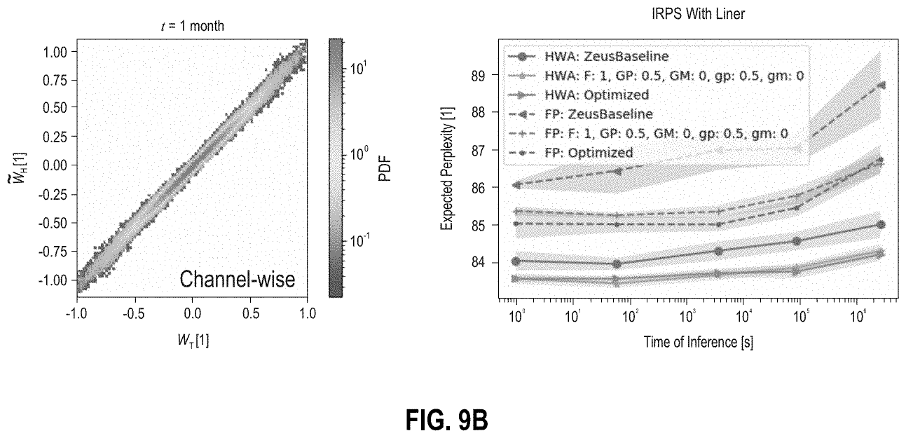

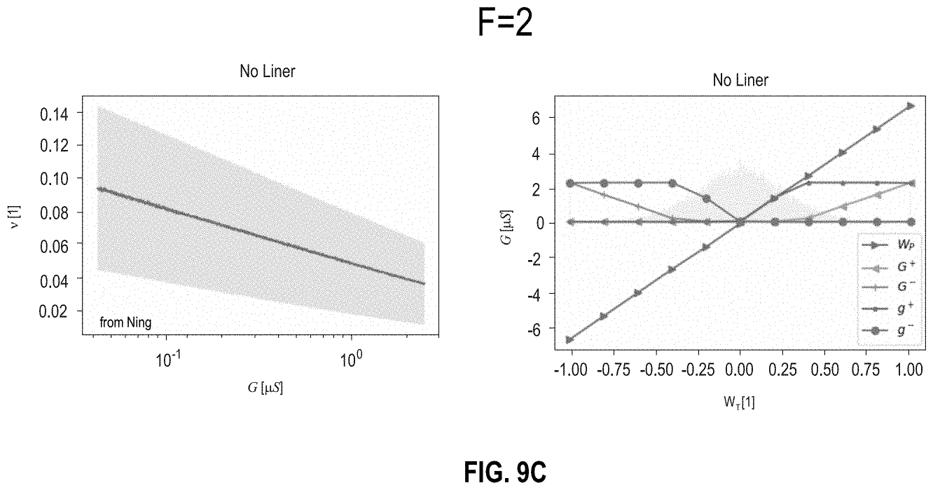

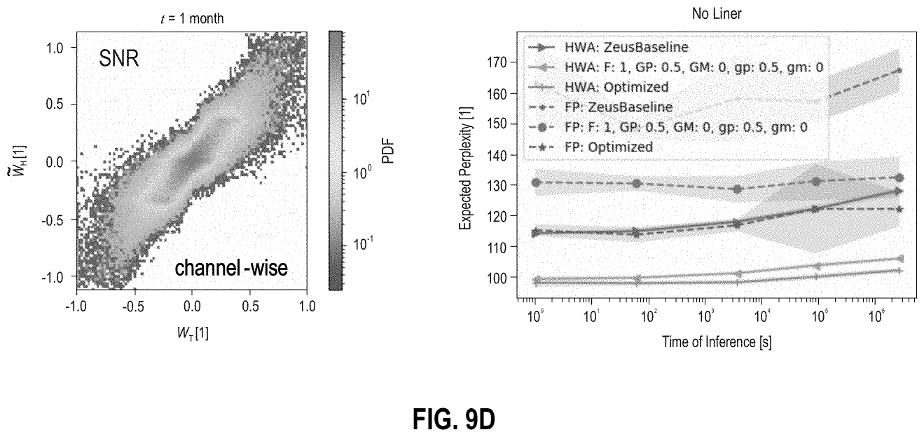

Referring to FIGS. 9A-D, further results of generalizing the model to different drift models are shown. FIGS. 9A-B correspond to a first case, and FIGS. 9C-D correspond to a second case. In this example, the No Liner case has less high quality results because using noise models are applied for a PCM device with very little conductance range. The SNR is poor, but the optimization still shows good results.

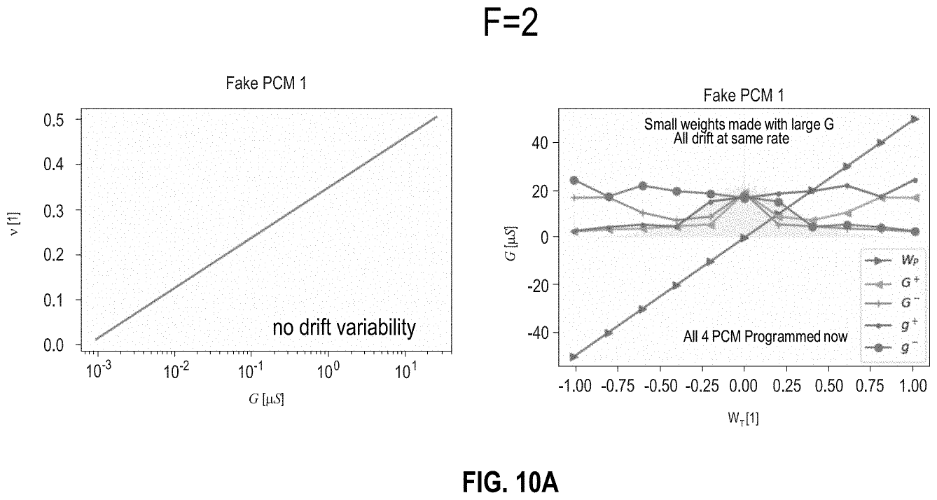

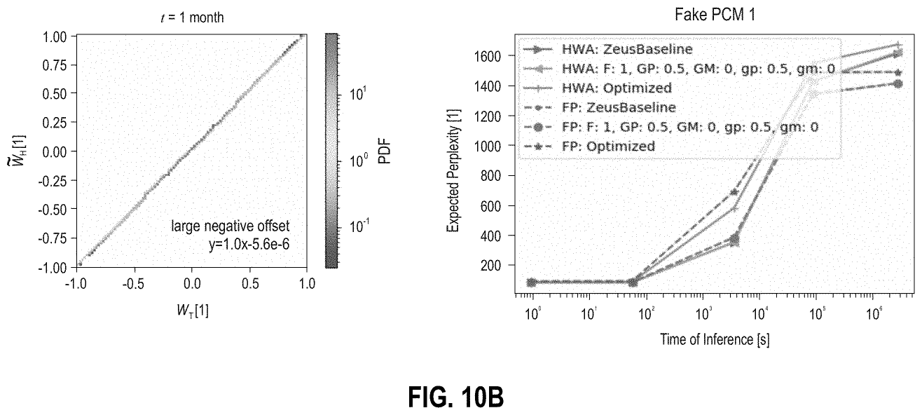

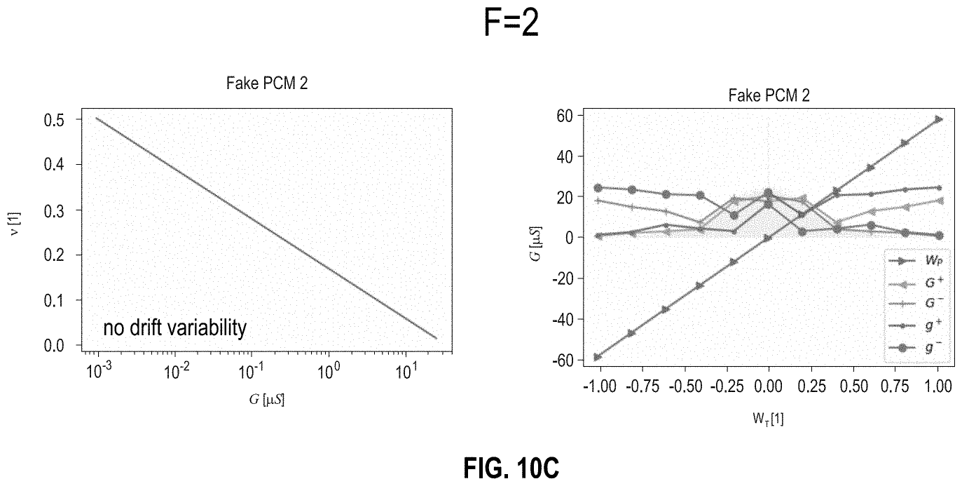

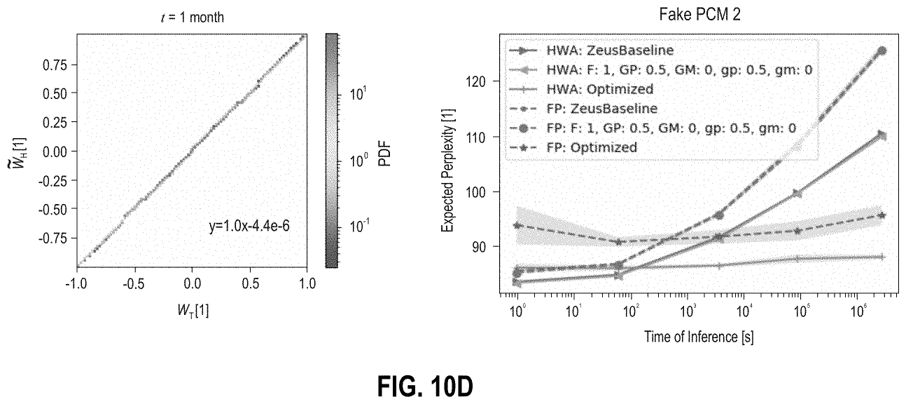

Referring to FIGS. 10A-D, further results of generalizing the model to different drift models are shown. FIGS. 10A-B correspond to a first case, and FIGS. 10C-D correspond to a second case. In this scenario, read_noise=prog_noise=0.0. This example is based on a fake PCM with extreme characteristics to better understand optimized programming strategies. Fake PCM 1 has worse performance than fake PCM 2.

In this example, affine_scale_new=affine_scale*sum(|w_ref|)/sum(|w_actual|) (and w is readout with ADC+noise).

It will be appreciated from these figures that weight programming optimizers according to the present disclosure can find other very non-obvious programming strategies that also greatly improve inference performance.

As set out above, automated processes are provided for finding optimal weight programming strategy in view of PCM programming errors, PCM read noise, and conductance-dependent drift, drift variability, and drift compensation. The weights are computed numerically so no limits on complexity of underlying device models.

In various embodiments, the time-averaged normalized mean square error is minimized. In various embodiments, schemes in which W_{T}: G⁺(W_{T}), G⁻(W_{T}), g⁺(W_{T}), g⁻(W_{T}) are employed. This results in non-obvious programming strategies

In various embodiments, the Error Metric employed is given in Equation 1.

$$\frac{1}{N T} {\sum }_{i = 1}^{T} {\sum }_{j = 1}^{N} {( \frac{{\hat{w}}_{i j} - {w}_{i j}}{max ( \vert W \vert )} )}^{2} \qquad Equation 1$$

In Equation 1: T are time steps of interest (over which we wish to preserve accuracy); N is the number of weights in the channel, tile, network (or any fraction thereof); Wᵢⱼ is the software-trained ideal weight; Ŵᵢⱼ is the effective hardware weight (after programming error, read noise, drift, drift compensation, and whatever other NVM non-idealities may exist), and W is the entirety of the weight distribution.

In an example of drift compensation, drift_comp=sum(|w_ref|)/sum(|w_actual|) (w is read out with ADC+noise). Drift compensation can occur at the channel level, tile level, or globally.

It will be appreciated that networks can have large number of weights (LSTM>20M). Accordingly, summing over N may be slow/unnecessary. Optimization can be accelerated by constructing histogram of Wᵢⱼ. In various embodiments, NS times are sampled at each histogram bin (unbiased) to capture/estimate variance due to noise, drift stochasticity, etc. A weighted sum is taken of normalized variance according to density/height of histogram bin. It will be appreciated that this can still be thought of a minimizing the original equation, with a minor modification of the Wᵢⱼ distribution.

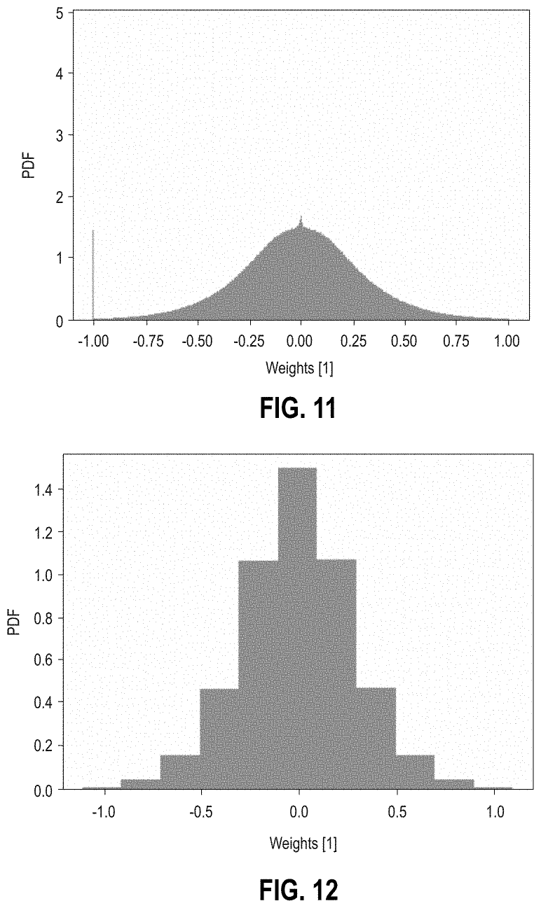

Referring to FIGS. 11-12, an exemplary distribution and exemplary histogram are illustrated (respectively). In FIG. 12, NS=100 samples at each of 11 bins.

In various embodiments, normalized mean squared error is employed. The normalization is employed because weight error relative to the magnitude (similar to SNR) is important to this use case. This leads to the following error metric expression:

$${\sum }_{i = 1}^{T} {\sum }_{j = 1}^{N} {[ \frac{( {\hat{W}}_{i j} - {W}_{i j} )}{max ( \vert W \vert} ]}^{2} \qquad Equation 2$$

where T is the number of time steps over which to optimize inference accuracy, N is the number of weights in the DNN, Ŵᵢⱼ is the unitless target weight including hardware associated errors, Wᵢⱼ is the ideal unitless target weight, and W represents the entirety of the DNN weight distribution.

Because there is also a need to optimize over millions of weights and each weight even if infinitesimally different in value can undergo a completely different programming strategy, the weight distribution (i.e., histogram) is discretized in various embodiments to limit the exploration space and maintain the tractability of the problem. For instance, we have four dimensions (G⁺, G⁻, g⁺, and g⁻) to explore for each weight.

Having N million weights, then requires exploring ˜4N million dimensions in the optimization space. This become very computationally expensive, particularly for non-convex and stochastic optimization problems where gradient descent-based methods are ineffective. Because of this, we discretize (i.e., histogram) the weight distribution, adapt the weight error metric accordingly, and prioritize the errors according to the weight densities in the histogram using αⱼ. This produces a less computationally expensive error metric:

$${\sum }_{i = 1}^{T} {\sum }_{j = 1}^{B} {α}_{j} {\sum }_{k = 1}^{S} {[ \frac{( {\hat{W}}_{ijk} - {W}_{ijk} )}{max ( \vert W \vert )} ]}^{2} \qquad Equation 3$$

which becomes equivalent to the previous weight error metric as the number of histogram bins B approaches the number of weights N, and the number of samples per weight S approaches one (meaning α₁ also approaches one). Here S represents a fixed number of samples, which is used to estimate the normalized mean squared error at each weight.

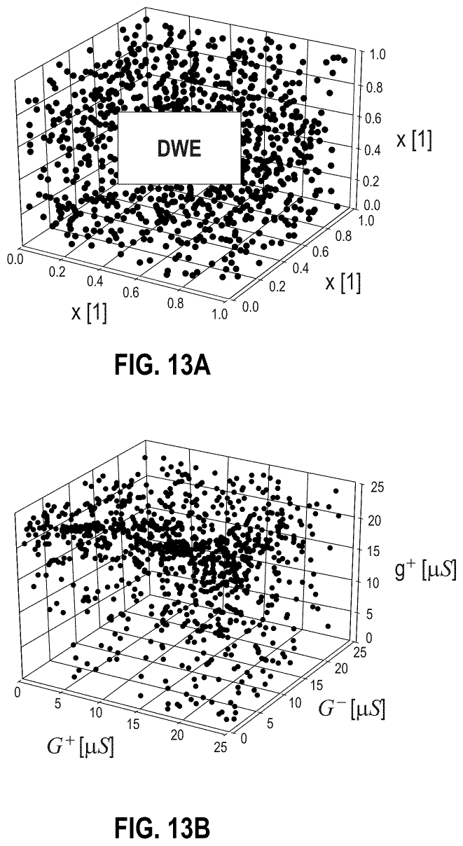

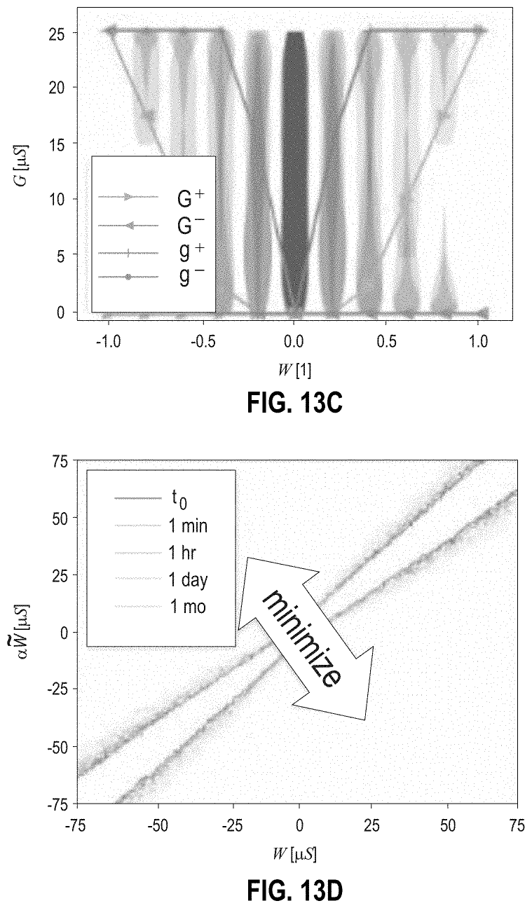

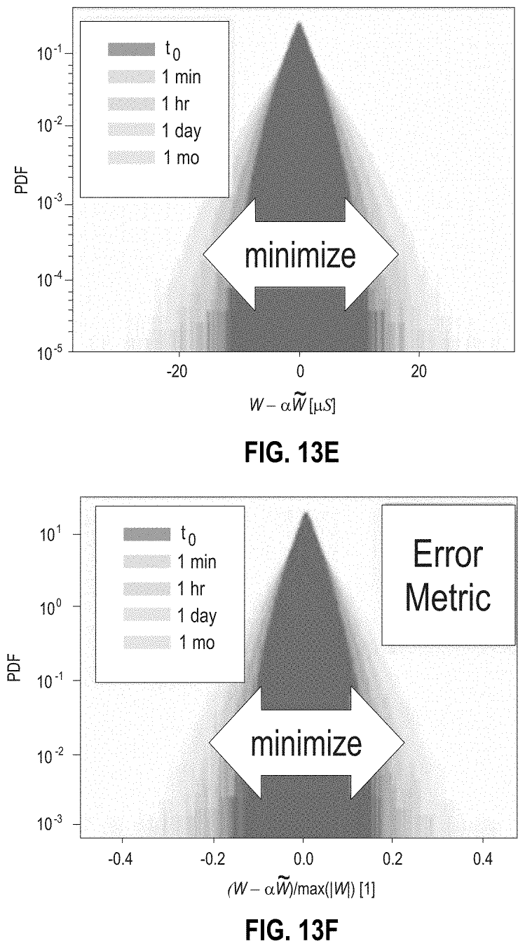

Referring to FIGS. 13A-F, the exploration of the weight programming space is illustrated. In FIG. 13A, parameter vectors x are shown that are sampled from a ˜4B dimensional hypercube, where N represents the number of discretized weight intervals from 0 to 1.0. In FIG. 13B, de-normalization of the hypercube parameters into valid combinations of G⁺, G⁻, g⁺, and g⁻ is shown to capture optimization constraints due to conductance interdependencies. In FIG. 13C, a two-dimensional projection of programming strategies is shown, with violin plots showing coverage for the weight programming space explored and also revealing some programming constraints. In FIG. 13D, correlation plots are provided of drift compensated hardware weights versus ideal weights showing an outward diffusion over time. In FIG. 13E, a corresponding probability density function of weight errors shows a similar outward diffusion with time. In FIG. 13F, the final normalized weight error distribution used to define the error metric that is minimized during the programming strategy exploration process is shown.

As set out above, various embodiments of the present disclosure provide method for optimizing the programming of analog non-volatile memory (NVM) by minimizing a time-averaged, normalized error metric. In various embodiments, programmed weights are compensated (restored) using drift compensation of the form aWᵢⱼ+b.

In various embodiments, unitless software-trained synaptic weights of an artificial neural network (ANN) are translated into target conductances for programming into analog non-volatile memory (NVM) devices. Software-trained unitless target weights (or some sub-sample of these weights) are taken. A weight programming strategy is applied, which makes use of one or more weight translation functions to map unitless software weights into weight programming target conductances for implementing synaptic weights in the analog NVM. Known device and hardware models are applied to simulate hardware effects such as weight programming errors, read noise, conductance drift, and/or drift variability. Initial programmed weights are calculated and the evolution of the programmed weights as a function of time based on these models is determined. The effects of any hardware correction techniques used on these weights is calculated (to compensate for weight imperfections such as drift for instance). These corrected hardware weights are translated back into the software domain. A weight error metric is evaluated based on the unitless software weights and the corrected and inverse translated hardware weights (back into software domain). The weight programming strategy is adapted one or more times to minimize the weight error metric.

It will be appreciated that a variety of error metrics are suitable for use as set out herein, including time-weighted normalized mean squared error, time-weighted normalized mean absolute error, down-sampled time-weighted normalized mean squared error, and down-sampled time-weighted normalized mean absolute error.

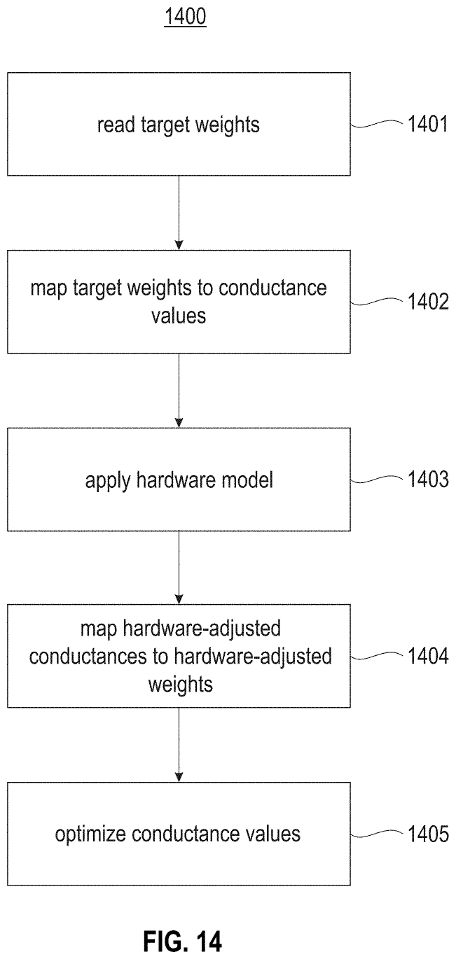

Referring to FIG. 14, a method of adapting an artificial neural network for deployment to an analog non-volatile memory device are provided. At 1401, a plurality of target synaptic weights of an artificial neural network is read. At 1402, the plurality of target synaptic weights is mapped to a plurality of conductance values, each of the plurality of target synaptic weights being mapped to at least one of the plurality of conductance values. At 1403, a hardware model is applied to the plurality of conductance values, thereby determining a plurality of hardware-adjusted conductance values, the hardware model corresponding to an analog non-volatile memory device. At 1404, the plurality of hardware-adjusted conductance values is mapped to a plurality of hardware-adjusted synaptic weights. At 1405, the plurality of conductance values is optimized in order to minimize an error metric between the target synaptic weights and the hardware-adjusted synaptic weights.

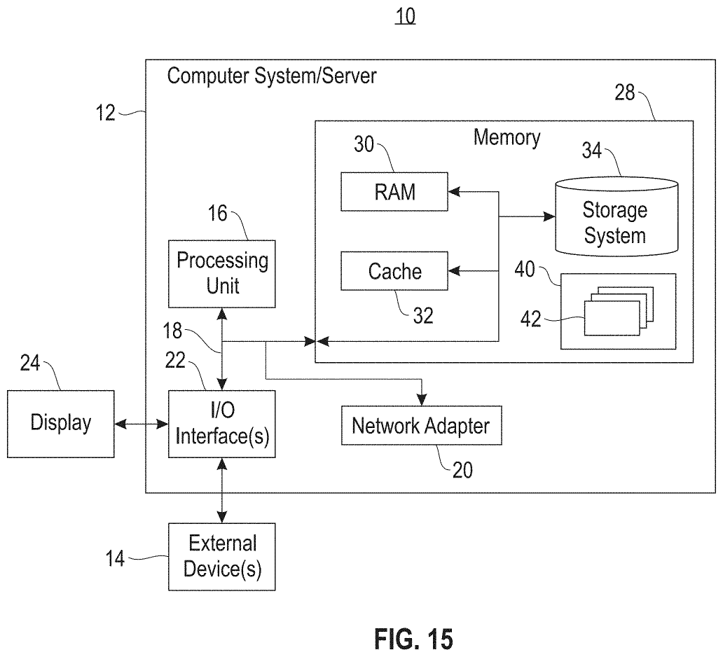

Referring now to FIG. 15, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 15, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of adapting an artificial neural network for deployment to an analog non-volatile memory device, the method comprising:
reading a plurality of target synaptic weights of an artificial neural network;
mapping the plurality of target synaptic weights to a plurality of conductance values, each of the plurality of target synaptic weights being mapped to at least one of the plurality of conductance values;
applying a hardware model to the plurality of conductance values, thereby determining a plurality of hardware-adjusted conductance values, the hardware model corresponding to an analog non-volatile memory device;
mapping the plurality of hardware-adjusted conductance values to a plurality of hardware-adjusted synaptic weights;
optimizing the plurality of conductance values in order to minimize an error metric between the target synaptic weights and the hardware-adjusted synaptic weights.

2. The method of claim 1, further comprising:
applying the optimized plurality of conductance values to the analog non-volatile memory device.

3. The method of claim 1, further comprising:
storing the optimized plurality of conductance values.

4. The method of claim 1, wherein the error metric is a time-averaged, normalized error metric.

5. The method of claim 4, wherein the error metric is a time-averaged normalized mean squared error.

6. The method of claim 4, wherein the error metric is a time-averaged normalized mean absolute error.

7. The method of claim 4, wherein the error metric is a down-sampled time-weighted normalized mean squared error.

8. The method of claim 4, wherein the error metric is a down-sampled time-weighted normalized mean absolute error.

9. The method of claim 1, wherein optimizing the plurality of conductance values comprises determining a coefficient and a constant adjustment to each of the plurality of conductance values.

10. The method of claim 1, wherein each of the plurality of target synaptic weights is mapped to at least two conductance values having opposite signs.

11. The method of claim 1, wherein each of the plurality of target synaptic weights is mapped to at least two conductance values having different magnitudes.

12. The method of claim 1, wherein each of the plurality of target synaptic weights is mapped to four conductance values, G⁺, G⁻, g⁺, and g⁻, wherein G⁺>g⁺ and G⁻>g⁻, and G⁺, g⁺ are added while G⁻, g⁻ are subtracted to obtain a resulting current.

13. The method of claim 1, wherein the hardware model comprises one or more of weight programming error, read noise, conductance drift, and drift variability.

14. The method of claim 11, wherein optimizing the plurality of conductance values comprises evolving the plurality of conductance values as a function of time based on the hardware model.

15. The method of claim 1, wherein the analog non-volatile memory device comprises an array of resistive elements, the array providing a vector of current outputs equal to the analog vector-matrix product between (i) a vector of voltage inputs to the array encoding a vector of analog input values and (ii) the plurality of conductance values within the array.

16. A system comprising:
an analog non-volatile memory device; and
a computing node comprising a computer readable storage medium having program instructions embodied therewith, the program instructions executable by a processor of the computing node to cause the processor to perform a method comprising:
reading a plurality of target synaptic weights of an artificial neural network;
mapping the plurality of target synaptic weights to a plurality of conductance values, each of the plurality of target synaptic weights being mapped to at least one of the plurality of conductance values;
applying a hardware model to the plurality of conductance values, thereby determining a plurality of hardware-adjusted conductance values, the hardware model corresponding to the analog non-volatile memory device;
mapping the plurality of hardware-adjusted conductance values to a plurality of hardware-adjusted synaptic weights;
optimizing the plurality of conductance values in order to minimize an error metric between the target synaptic weights and the hardware-adjusted synaptic weights; and
applying the optimized plurality of conductance values to the analog non-volatile memory device.

17. The system of claim 16, the method further comprising:
applying the optimized plurality of conductance values to the analog non-volatile memory device.

18. The system of claim 16, the method further comprising:
storing the optimized plurality of conductance values.

19. The method of claim 16, wherein the error metric is a time-averaged, normalized error metric.

20. The system of claim 19, wherein the error metric is a time-averaged normalized mean squared error, a time-averaged normalized mean absolute error, a down-sampled time-weighted normalized mean squared error, or a down-sampled time-weighted normalized mean absolute error.

21. The system of claim 16, wherein each of the plurality of target synaptic weights is mapped to at least two conductance values having opposite signs.

22. The system of claim 16, wherein each of the plurality of target synaptic weights is mapped to at least two conductance values having different magnitudes.

23. The system of claim 16, wherein the hardware model comprises one or more of weight programming error, read noise, conductance drift, and drift variability.

24. The system of claim 24, wherein optimizing the plurality of conductance values comprises evolving the plurality of conductance values as a function of time based on the hardware model.

25. A computer program product for adapting an artificial neural network for deployment to an analog non-volatile memory device, the computer program product comprising a computer readable storage medium having program instructions embodied therewith, the program instructions executable by a processor to cause the processor to perform a method comprising:
reading a plurality of target synaptic weights of an artificial neural network;
mapping the plurality of target synaptic weights to a plurality of conductance values, each of the plurality of target synaptic weights being mapped to at least one of the plurality of conductance values;
applying a hardware model to the plurality of conductance values, thereby determining a plurality of hardware-adjusted conductance values, the hardware model corresponding to an analog non-volatile memory device;
mapping the plurality of hardware-adjusted conductance values to a plurality of hardware-adjusted synaptic weights; and
optimizing the plurality of conductance values in order to minimize an error metric between the target synaptic weights and the hardware-adjusted synaptic weights.
